(19) United States
(12) Patent Application Publication
(10) Pub. No.: US 2026/0044822 A1
(43) Pub. Date: Feb. 12, 2026

(54) PROXIMITY-BASED APPLICATION FOR SELF-SERVICE ITEM INDUCTION

(71) Applicant: United States Postal Service, Washington, DC (US)

(72) Inventors: David C. Lin, Falls Church, VA (US); Larry B. Jenkins, II, Odessa, FL (US); Peter Jay Klausner, Scottsdale, AZ (US); Gary C. Reblin, Falls Church, VA (US); Christina Zavas, Arlington, VA (US); Kison E. Shin, McLean, VA (US)

(21) Appl. No.: 19/295,421

(22) Filed: Aug. 8, 2025

Related U.S. Application Data
(60) Provisional application No. 63/680,995, filed on Aug. 8, 2024.

(51) Int. Cl. G06Q 10/087; G06K 7/14

(52) U.S. Cl. CPC G06Q 10/08744; G06K 7/1417

(57) ABSTRACT

Systems, methods, and devices of the present disclosure describe a self-service labeled induction of an item into a distribution network using an induction application. In some embodiments, an induction application may be downloaded on a third party device of a sender, such as a mobile phone. In other embodiments, the induction application may run on devices internal to systems of the item distributor. An induction application may use geolocation functionality or proximity sensors to make a determination regarding the authenticity of an item submitted for self-service drop off at an authorized receptacle of the distributor. An induction application may further communicate with other devices, kiosks, and stations having functionality to create or generate labels corresponding encrypted machine-readable identifiers for the labels, thus allowing for the transfer of incomplete label transactions between the induction application and other authorized devices.

### BACKGROUND

### Field

The present disclosure relates to the field of induction of items into a distribution network and the associated labels for shipping and payment.

### Description of the Related Art

Item distribution generally requires an indication on an item of the destination and indicia of payment for distribution of the item. Some individuals or entities wishing to ship items may not have the means for generating a label having computer-readable indicia thereon. Systems, methods, and devices described herein relate to an application for label generation and proximity-based self-service item deposit and induction.

### SUMMARY

The systems, methods, and devices of the present disclosure have several innovative aspects, none of which are solely responsible for the novelty disclosed herein. In one innovative aspect, a disclosed system provides self-service labeled induction of an item into a distribution network. The system includes: an induction application configured to facilitate self-service transactions generating a label to affix to an item to be distributed via a distribution network. To facilitate self-service label transactions, the induction application is configured to receive a request for a label for the item from a third party device or a device internal to the system. The induction application is further configured to create a label based on the request for the label and transmit, to a distribution server, the created label for the item. The system also includes the distribution server which is in communication with the induction application. The distribution server is configured to generate a machine-readable identifier for the label. The distribution server is also configured to store, in a data storage device, the created label and an association between the created label and the machine-readable identifier. The distribution server is configured to receive, from an induction communication device, the machine-readable identifier for the label. The distribution server is further configured to retrieve the created label from the data storage device based at least in part on the machine-readable identifier. The distribution server is configured to cause, via the induction communication device, generation of a physical label based at least in part on the created label retrieved from the data storage device, where the generation of the physical label may be deferred for a period of time subsequent to the generation of the machine-readable identifier. Other embodiments of this innovative aspect include corresponding computer systems, apparatuses, and computer programs recorded on one or more computer storage devices, each configured to perform the actions of the methods.

Implementations may include one or more of the following features. The system may include an authorized induction receptacle for storing an item. The authorized induction receptacle may include a locking means for securing the authorized induction receptacle and a scanning device for detecting information from the physical label. The distribution server may be further configured to receive scanned information on the physical label from the scanning device and use this scanned information to retrieve a disposition status for the item from the data storage device indicating whether the item has been inducted into the distribution network. The distribution server may be further configured to determine that the item has not been inducted to the distribution network based at least in part on the disposition status and subsequently transmit a message to the locking means causing the locking means to permit access to the induction receptacle.

In some embodiments, the distribution server may be configured to receive geolocation information or other similar proximity indicators from the induction application. The induction application may make use of native capabilities of a third party device such as a mobile device to determine where a request for a label, a reading of a label, or any other behavior in association with the induction of an item into a distribution network to determine or confirm the location of the label transaction in proximity to an authorized induction receptacle before allowing the item to be inducted into the distribution network. In other embodiments, the distribution server may be configured to receive location information from the induction application through metadata contained in photographs of a label submitted to the distribution server from the induction application. Such location information may be used by the distribution server to determine or confirm the location of the label transaction in proximity to an authorized induction receptacle before allowing the item to be inducted into the distribution network.

In some embodiments, the distribution server may be further configured to receive a confirmation via the induction communication device that the physical label has been created and store an indicator that the physical label has been created in association with the machine-readable identifier in the data storage device. The distribution server may be further configured to receive the machine-readable identifier for the label from the induction application, determine that the physical label has been created based on the indicator and the machine-readable identifier, and transmit a message to the induction application indicating that the physical label has been created. In some implementations of the system, the label may include a sender address identifying a location from which the item is being distributed. The distribution server may be further configured to receive location information for the induction communication device from the induction communication device and determine that the location information for the induction communication device is within a threshold distance of the sender address. In this configuration, the physical label is generated in response to the distribution server determining that the location information is within the threshold distance of the sender address.

Additionally or alternatively, the induction application may be configured to receive a transfer request to complete a previously-stored incomplete label transaction from a third party device or a device internal to the system. The induction application may be configured to create a label upon completion of the transfer request and transmit the created label to a distribution server.

Additionally or alternatively, the distribution server may be further configured to receive scanned information on the physical label from a scanning device, confirm that the scanned information corresponds to the item, and route the item to an item processing equipment for a distribution network based at least in part on the scanned information. The physical label may include an identifier indicating that the physical label was generated by the distribution server based on a request from the induction application. The item processing equipment may include a postage canceler, and the distribution server may be configured to route the item to bypass the postage canceler in response to receiving the confirmation.

Some embodiments of the system may include a labeling kiosk. The induction application may communicate with the labeling kiosk. The labeling kiosk may include an input interface for receiving machine readable identifiers for labels. The input interface may include a scanning device or a graphical user interface. The created label may include a data file containing information for generating the physical label. For example, the created label may include an image of the label or personal identifying information of the label requestor. In some implementations, receiving the machine-readable identifier may include receiving the machine readable identifier from a portable, handheld scanning device associated with a distribution resource of the distribution network. The distribution server may be further configured to transmit the machine-readable identifier for the label to the induction application. The innovative features described may include or be implemented by hardware, a method or process, or computer software on a computer-readable medium.

In another innovative aspect, a disclosed system provides self-service labeled induction of an item into a distribution network. The system includes one or more processing devices to execute machine readable instructions stored on a computer-readable storage medium. When executed by the one or more processing devices, the machine readable instructions cause the system to receive information from the induction application for creating a label for distributing an item via a distribution network. The instructions cause the system to create a label using the received information as well as a machine-readable identifier for the label. The instructions cause the system to store the created label and an association between the created label and the machine-readable identifier in a data storage device. The instructions further cause the system to transmit the machine-readable identifier for the label to a first communication device. The instructions also cause a second communication device to receive the machine-readable identifier for the label. The instructions cause the system to retrieve the created label from the data storage device based at least in part on the machine-readable identifier and generate a physical label via the second communication device based at least in part on the created label. Other embodiments of this aspect include corresponding computer systems, apparatus, and computer programs recorded on one or more computer storage devices, each configured to perform the actions of the methods.

Implementations may include one or more of the following features. When executed by the one or more processing devices, the machine-readable instructions may further cause the system to receive a confirmation that the physical label has been generated via the second communication device and store an indicator that the physical label has been generated in association with the machine-readable identifier in the data storage device. The machine-readable instructions may further cause the system to receive the machine-readable identifier for the label from another communication device, retrieve a disposition status for the item associated with the label from the data storage device based at least in part on the machine-readable identifier, determine that the disposition status corresponds to an unauthorized status indicating that the label is no longer authorized for inducting the item to the distribution network, and transmit a message to the another communication device indicating that the label is unauthorized. A determination that the label is unauthorized may be made due to proximity or location data related to the label.

In some embodiments, the machine-readable instructions, when executed by the one or more processing devices, may further cause the system to receive a sender address identifying a location from which the item is being distributed, receive location information for the second communication device from the second communication device, and determine that the location information for the second communication device is within a threshold distance of the sender address, where the physical label is generated in response to determining that the location information is within the threshold distance of the sender address. In one embodiment of the system, the physical label includes an identifier indicating that the physical label was generated based on a request from the induction application, and where the distribution network includes a postage canceler, and where the machine-readable instructions, when executed by the one or more processing devices, further cause the system to at least route the item to bypass the postage canceler based at least in part on a disposition status for the item.

Some implementations of the system include an induction receptacle for storing an item, where the induction receptacle includes a locking means for securing the induction receptacle and a scanning device for detecting information from the physical label. The machine-readable instructions, when executed by the one or more processing devices, may further cause the system to receive scanned information on the physical label from the scanning device, retrieve a disposition status for the item from the data storage device indicating whether the item has been inducted into the distribution network based at least in part on the scanned information, determine that the item has not been inducted to the distribution network based at least in part on the disposition status, and transmit a message to the locking means causing the locking means to permit access to the induction receptacle. In one embodiment, the induction receptacle may include measurement means configured to collect measurement information a physical characteristic of the item.

The information for creating the label may include a specified value for the physical characteristic (e.g., weight, size, packaging). The machine-readable instructions, when executed by the one or more processing devices, may further cause the system to store the specified value in association with the machine-readable identifier in the data storage device, retrieve the specified value for the label from the data storage device based at least in part on the machine-readable identifier, and determine that the measurement information corresponds to the specified value for the physical characteristic, where the message is transmitted after determining that the measurement information corresponds to the specified value. The innovative features described may include or be implemented by hardware, a method or process, or computer software on a computer-accessible medium.

The foregoing is a summary and thus contains, by necessity, simplifications, generalization, and omissions of detail. Consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is an illustrative block diagram of a system for self-service labeled induction of an item into a distribution network using an induction application.

FIG. 2 is an illustrative system architecture diagram of a system for self-service labeled induction of an item into a distribution facility using an induction application, including numerous illustrative application programming interfaces (APIs) in communication with the induction application.

FIG. 3 is a flow chart depicting an embodiment of a process for transferring an incomplete label transaction from a first device to a second device.

FIG. 4 is a flow chart depicting an embodiment of a process for conducting a proximity-verified self-service acceptance scan of a label for an item to be inducted using the proximity detection capabilities of an induction application in communication with an authorized item receptacle.

FIG. 5 depicts illustrative wireframe examples for an induction application in which a label is imported to the induction application.

FIG. 6 depicts illustrative wireframe examples for an induction application in which a machine-readable identifier for a label is displayed for scanning.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification does not necessarily mean that these phrases all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

As used herein, an item can be a parcel, a package, an envelope, a flat, a mail piece, a box, a suitcase, or any other item that can be transported from one location to another by a distribution entity. A distribution entity may be an entity engaged in transporting items from one location to another, such as the United States Postal Service (USPS), another commercial carrier, a storage facility, a fulfillment warehouse, a luggage sorting facility, or any other similar facility, company, or entity.

Using the USPS as an example, an item, such as a parcel, mail piece, or the like has a label thereon, or information printed directly on the item (also referred to as a label herein), which indicates, among other things, a sender, a delivery point (destination), a class of service, postage, and a tracking code. The labels include computer-readable codes which encode the above items of information. The information contained in the computer-readable code must be regulated and formatted uniformly in order to be read, understood, and processed within the USPS's distribution networks. Entities including the USPS and other entities can create labels which include postage and other information for distribution within the USPS. As used herein, creating a label can refer to the process for producing or making an electronic label, such as an electronic image of a label, a data file including label information, and the like. The USPS and other entities can be enabled to generate labels, that is, can print physical embodiments of the created labels and attach the labels to the items. As used herein, generating a label can refer to the process of producing, making, or printing a physical embodiment of a label. Generating the label can include obtaining electronic information from the created label in order to produce the physical label, as will be described herein. Some generating entities are involved with processing the label and postage, but do not have access to the physical item to be shipped. Additionally, some entities, such as individuals or businesses may wish to print their own labels, rather than going to the post office or other distribution facility. In such an instance, the user requests creation of a label for a particular item. The created label will include a destination and a postage indicia, and the label information can be sent to the individual or business for generation (e.g., printing) and attaching to the item to be sent.

When a sender has started a transaction and does not want to or cannot finish the transaction, the mobile application can identify the location of a distribution facility the sender can go to complete the transaction. In some embodiments, the mobile application and the second computing device, (e.g., kiosk, counter, etc.) can exchange transaction information, for example, the application can transfer the transaction information to the kiosk or counter, when a criteria is met. The criteria can be a geofence criteria, a location criteria, a token exchange, a digital handshake, and the like prior to transferring the transaction information. In some embodiments, the sender may select a particular facility to complete the transaction. The mobile application may transfer the transaction information only to a computer associated with the selected particular facility.

A sender may begin a transaction on a first device, such as requesting a shipping label on a phone via a mobile application. The sender may not have the information, tools, or desire to complete the transaction on the mobile application, and instead will go to a distribution facility, such as a post office, to finish the transaction. The mobile application can save the progress of the label creation event, provide a code or identifier, which can then be scanned at a self-service kiosk, at a counter, or by an employee. If the item requires a weight or size measurement, the sender may not have this information, and so the sender will continue or complete the transaction at a distribution network facility that has a scale or other equipment. The sender will present the code in the mobile application to a secondary device, such as the kiosk or counter, the transaction information will be imported to the second device, and the sender can continue the transaction.

Systems described herein for controlling, requesting, and coordinating the creation and generation of labels can be facilitated by an induction application, providing a centralized location for storing label information created by various entities and managing the requests for generation of physical labels coming from various sources and entities.

Some entities (e.g., an individual or small business wishing to send an item via a distribution network) may have computer capabilities without having printing capabilities. Alternatively, some entities may not wish to print the label. In such instances, the sending entity can request a shipping label, pay postage, and prepare the item for shipping. The entity can then go to a post office or to an item receptacle with label printing capability, such as an item induction unit. The entity can request generation of a label (e.g., printing a physical label) at an item receptacle such as at a self-service location without needing to wait in line at a post office or other shipping facility.

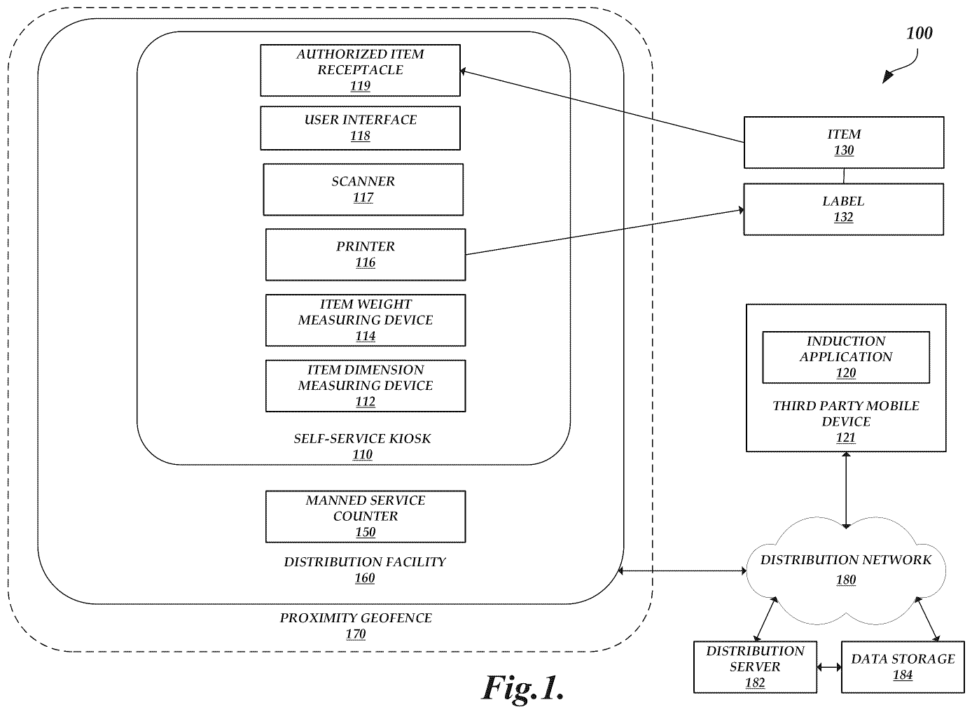

FIG. 1 is an illustrative block diagram of a system 100 for self-service labeled induction of an item 130 into a distribution facility 160 using an induction application 120 in communication with a distribution network 180. The distribution facility 160 may be instantiated in a variety of physical locations with varying access points for senders of an item 130 with a label 132. For example, the distribution facility may take the form of a USPS office, self-service drop point, or other similar item receptacle in communication with the distribution facility 160. An induction application 120 may be a computer application or mobile application downloaded onto a computing device such as a third party mobile device 121 (e.g., a smartphone). The third party mobile device 121 can be a tablet computer or cellular phone capable of RF, 3G, 4G, LTE, Bluetooth, Wi-Fi, or other similar wireless communication protocols. The third party mobile device 121 includes a display screen facilitating the label transaction. The induction application 120 on the third party mobile device 121 may communicate with the distribution network 180 to facilitate label transactions and proximity verification for self-service item deposit.

In some embodiments, the physical location of distribution facility 160 may include a kiosk or station such as self-service kiosk 110. A self-service kiosk 110 may contain tools that facilitate the unmanned, self-service drop off of an item into a distribution facility 160, such as an item dimension measuring device 112, an item weight measuring device 114, a printer 116, a scanner 117, a user interface 118, and an authorized item receptacle 119. An item dimension measuring device 112 may be a physical measurement tool such as a ruler or measuring tape for determining distinct units of measurement related to the dimensions of an item 130 (e.g., width, length, or height). An item dimension measuring device 112 could also be a computing device with software configured to determine the dimensions of a physical item (e.g., using scanning or laser technologies). The item dimension measuring device 112 may communicate dimensions via the distribution network 180 for storage by the distribution server 182 in data storage 184. The distribution server 182 may use these dimensions to populate a relevant label transaction. An item weight measuring device 114 may be any type of analog or digital scale configured to determine, in units of measurement, the weight of an item 130. The item weight measuring device 114 may communicate item weight via the distribution network 180 for storage by the distribution server 182 in data storage 184. The distribution server 182 may use the item weight to populate a relevant label transaction.

A self-service kiosk 110 may also include a printer 116. A printer 116 may be any computing device configured to receive information from the distribution network 180 regarding items to print, such as a label 132. The printer 116 may be used to generate (e.g., print) a label 132 for an item 130 at the distribution facility 160. The printer 116 can provide a variety of printed documents to a user beyond labels, such as an acceptance verification receipt, a receipt for purchase of shipping services, or a payment indicia (e.g., postage). The printer 116 can print on a label having an adhesive on one side thereon. In some embodiments, the printer 116 can spray a label or code onto an item to be deposited. In some embodiments, the printer 116 can print a label, postage, computer-readable code and the like on an item which has been deposited into the authorized item receptacle 119. In such embodiments, the printer 116 can comprise a moveable print head that can extend to contact a surface of the item to be deposited or to the item after deposit.

A scanner 117 may be any computing device (e.g., a camera, an optical scanner, a laser barcode scanner, or any other optical signal acquisition device used to scan a machine-readable identifier (e.g., a barcode, a Quick Response “QR” code, an label identifier, etc.) in order to query a distribution server 182 on the distribution network 180 for a machine-readable identifier stored in data storage 184 and associated with the label 132. The scanner 117 may also be configured to read payment or other information, such as a barcode or QR code on a label, printout, smartphone or tablet screen, and may be configured to take images for proof of deposit, such as an image of an item being deposited or of the person depositing the item 130. The information read by the scanner 117 may be referred to as scanned information.

A user interface (“UI”) 118 may be a computing device with a screen allowing for input by a sender of an item 130 at a self-service kiosk 110 to interface with the capabilities of the distribution network 180 in order to retrieve and generate a label and submit an item 130 for induction at a distribution facility. The UI 118 can include a near field communication, Bluetooth, or similar wireless protocol transfer capable of receiving information from a wireless computing device. In some embodiments, a UI 118 may be used as alternative to an induction application 120 downloaded on a third party mobile device 121 of a sender (e.g., a smartphone). For example, a UI 118 may be an interface for a computing device of the distribution facility 160 that is running the induction application 120 directly on that computing device (not pictured) rather than a sender's third party mobile device. In yet another embodiment, as is shown in FIG. 1, a UI 118 may be in communication with an induction application 120 on a third party mobile device 121 via a distribution network 180. In this example, the computing device running the UI 118 may work in tandem with the induction application 120 on the third party mobile device 121 to transfer incomplete label transactions. In other instances, a sender may only use the induction application 120 on the third party mobile device 121 to facilitate a label transaction or only use the UI 118 to facilitate a label transaction. The UI 118 can be configured for various purposes related to receipt, deposit, labelling, shipping, and item distribution. For example, the UI 118 can be a display screen having an interface. In some embodiments, the interface can be incorporated into the UI 118, such as a touch screen interface, or can comprise a keypad, keyboard, one or more hard keys or soft keys, and the like. The UI 118 is configured to receive user input and provide user notifications. In some embodiments, the screen may be only a display screen, or may be an interactive screen such as a touch screen configured to display graphic or text content and to receive tactile input from a user. A keypad can be provided as an alternative or additional input interface if the screen is a touch screen, or it can be the primary input device if the screen is not capable of receiving input. The UI 118 may comprise or be implemented as a portable handheld scanning device to facilitate use by a delivery agent (e.g., postal carrier or other distribution resource) moving between locations.

Once a label transaction has been completed and a label 132 is generated for the item 130, the label 132 is affixed to the item 130. Once an item 130 is ready for self-service deposit, it may be submitted to the distribution facility 160 via an authorized item receptacle 119 of a self-service kiosk 110. The authorized item receptacle 119 may include an item receiving portion including a rotatable drum and a handle. The item receiving portion is configured to receive an item within the drum when rotated to an open position, and can further be configured to automatically drop the item into a box, bin, or other collection container behind a wall when the drum is returned to a closed position. For example, in some embodiments, the wall drum can be a cylinder mounted partially in the wall so as to rotate about a longitudinal axis passing through the two circular end faces of the cylinder. The drum can include a cavity or opening in the side of the cylinder, configured to receive an item. In one example, the cavity can include a radial wedge-shaped portion of the cylinder. The cavity can be positioned such that the cavity is exposed to the outside when the drum is in an open position. The cavity can further be configured to allow an item within the cavity to fall out of the drum and into a collection container due to gravity, when the drum is in a closed position.

The drum can be rotated from the closed position shown to an open position by moving the handle downward. An intermediate position can be a rotational position between the open position and the closed position. For example, an intermediate position may be relatively close to the closed position so as to prevent a user from taking an item out of the drum, while also being far enough from the closed position such that gravity does not cause the item within the drum to fall into the collection container. In some embodiments, the item receiving portion can be configured to open similar to a locker, have a roll-up door, or be of another desired configuration which is capable of opening, receiving an item, and closing such that, after an item is deposited in the item receiving portion, the item is not accessible to another user or entity. It will be understood that the authorized item receptacle 119 can have a variety of configurations without departing from the scope of the present disclosure. The item receiving portion may be configured to be operable manually, such as by a user of the authorized item receptacle 119 rotating the drum by the handle. In some embodiments, the item receiving portion may be configured to be operated automatically by one or more motors controlled by computer elements of the authorized item receptacle 119. The authorized item receptacle 119 may further include one or more locks (not shown) controlled by computer elements of the item receptacle 100 and configured to prevent the drum from rotating. The one or more locks may be configured to lock the drum in an open position, a closed position, and/or an intermediate position between open and closed. For example, an intermediate position may be sufficiently closed to prevent an item in the drum from being removed (e.g., “trapping” the item), while being far enough from a fully closed position that the item in the drum does not drop from the drum into the collection container. An intermediate position may advantageously allow the authorized item receptacle 119 to secure an item for verification of postage, size, and/or weight, while also allowing the item receiving portion to return the item to a user if acceptance of the item is rejected by the authorized item receptacle 119 or by the user.

In some embodiments, the authorized item receptacle 119 may be in communication with the UI 118. The UI 118 may provide an input interface to request or receive information for distributing an item.

In some embodiments, an item 130 may not be submitted for self-service deposit until the proximity of the sender attempting the deposit is verified. Such verification may use a variety of methods and devices, such as a proximity geofence 170 defining a designated radius around a distribution facility 160 (as shown in FIG. 1), a self-service kiosk 110, or an item receptacle 119. A sender's location may be determined through a variety of methods discussed at length elsewhere in this disclosure, such as making use of the location services and Bluetooth capabilities of a third party mobile device 121 of the sender attempting to submit an item for deposit. In some embodiments, the item receiving portion of the authorized item receptacle 119 described above may only allow item deposit upon satisfaction of proximity or geofence 170 requirements.

In alternative embodiments, some distribution facilities may make use of manned service counters 150 for item deposit in addition to or instead of providing self-service options such as a self-service kiosk 110.

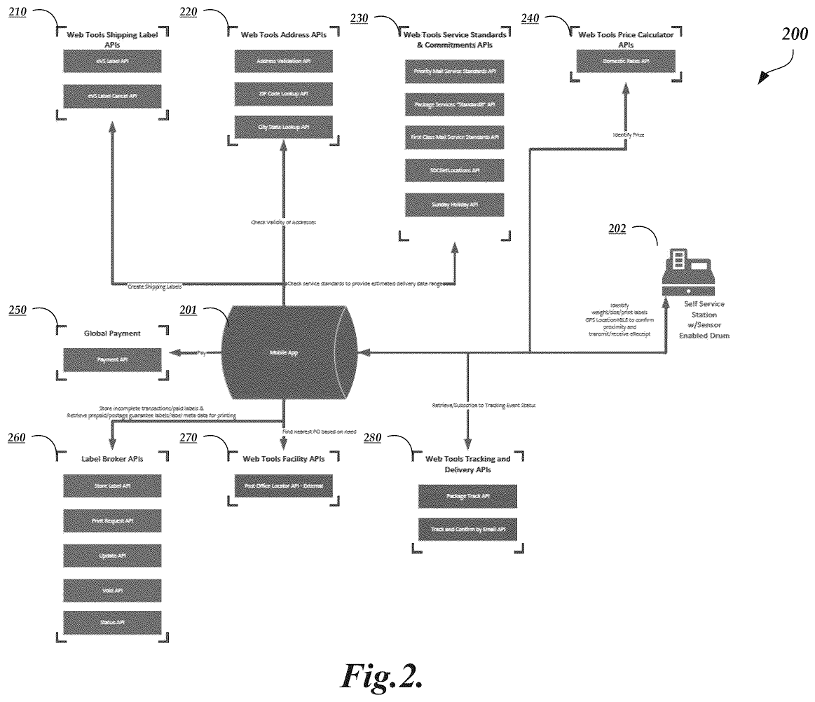

FIG. 2 is an illustrative system architecture diagram 200 of a system for self-service labeled induction of an item 130 into a distribution facility 160 using an induction application 120, including numerous illustrative application programming interfaces (APIs) in communication with the induction application. The mobile application 201 represents an embodiment of the induction application 120, and the self-service station with a sensor-enabled drum 202 represents an embodiment of the self-service kiosk 110. Each arrow represents a connection over the distribution network 180 between various entities of FIG. 2 and corresponding APIs. For example, the Web Tools Shipping Label APIs 210, the Web Tools Address APIs 220, and the Web Tools Service Standards and Commitments APIs 230 are called by the mobile application 201 to create shipping labels, check address validity, and check service standards to provide estimated delivery date range, respectively. The mobile application 201 may call the Web Tools Price Calculator APIs 240 to identify the price of a label transaction. The mobile application 201 may call the Global Payment API 250 to receive payment for a label transaction. The mobile application 201 may call the Label Broker APIs 260 to store incomplete transactions or labels that have already been paid for, retrieve prepaid and postage guarantee labels, and retrieve label metadata for pricing purposes. The mobile application 201 may call the Web Tools Facility APIs 270 to find the nearest distribution facility 160 based on user location or request. The mobile application 201 may call the Web Tools Tracking and Delivery APIs 280 to retrieve and subscribe to tracking event statuses for items already inducted. The mobile app may make use of all the information from these various APIs when in communication with the self-service station 202.

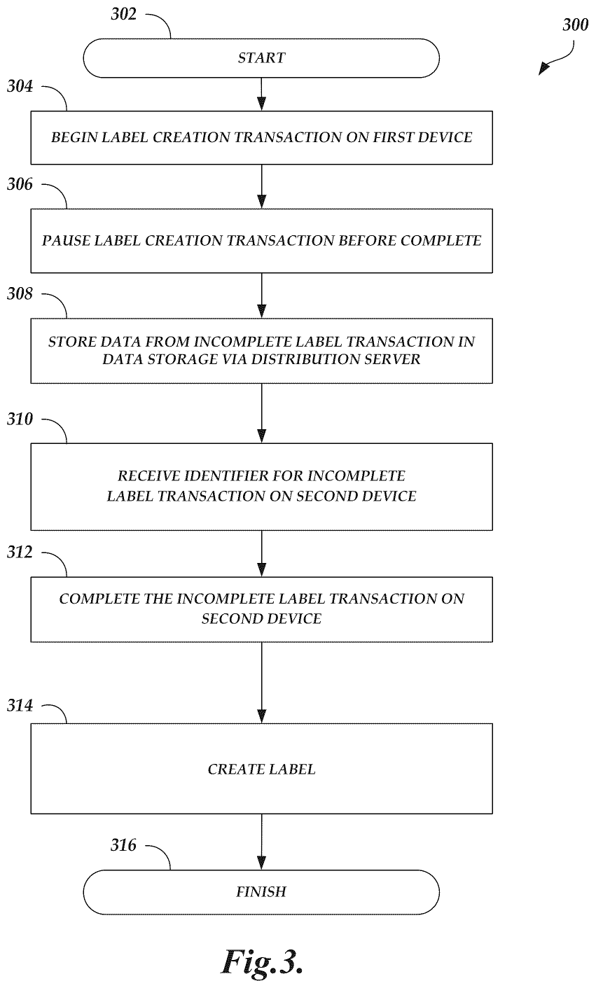

FIG. 3 is a flow chart depicting an embodiment of a process 300 for transferring an incomplete label transaction from a first device to a second device. The process 300 begins at block 302. At block 304, a label creation transaction is initiated on a first device when a request is made by the first device to access the induction application 120 over the distribution network 180. The first device may be a third party mobile device 121 with an induction application 120, a computing device of a distribution facility 160 accessible by a UI 118, or any other similar source such as an interface provided by an e-commerce merchant. The request to access the induction application 120 can come in the form of entering login credentials to the induction application 120. After logging in, a transaction to create a label begins, and various information regarding a label transaction may be input by a user on a screen or through wireless or wired connection to other parts of the system 100 such as the item dimension measuring device 112 or the item weight measuring device 114. The transaction for creation of a label can comprise a user inputting information related to the item for shipment, such as sender information, recipient information, item dimensions, item weight, item value, destination information, and other desired information. This information can be provided to the induction application 120 via an interface such as the screen on a third party mobile device 121 or a UI 118.

The process 300 then moves to block 306, where the label transaction may be paused prior to its completion. This pause may be necessitated by any number of reasons such as convenience or a need for further information at a later time. Due to the pause functionality, a user is not forced to complete a label transaction in one sitting, but rather has the option to come back to their saved progress on a label transaction at the time and place most convenient for them.

At block 308, the distribution server stores the data from the paused incomplete label transaction in data storage 184 via the distribution network 180. Upon storing the data from the paused incomplete label transaction in data storage 184, the distribution server also creates a machine-readable identifier for the label transaction and stores the machine-readable identifier in connection with the incomplete label transaction. At this point, any number of devices, services, or APIs may access the incomplete label transaction through a call by a distribution server 182 to data storage 184 over the distribution network 180.

At block 310, a second device different from the first device receives the machine-readable identifier from the distribution server 182 for the incomplete label transaction stored in block 308 from the first device. This second device, like the first device, may be a third party mobile device 121 with an induction application 120, a computing device of a distribution facility 160 accessible by a UI 118, or any other similar source such as an interface provided by an e-commerce merchant. The second device is any device that is different from the first device while also in communication with the distribution network 180 for the purpose of a label transaction. In this way, any number of devices may interchangeably pick up where the last device left off in an incomplete label transaction: a third party mobile device may begin and then pause an incomplete label transaction, and then a computing device at a distribution facility 160 may receive the incomplete transaction's machine-readable identifier upon request to resume the label transaction. Alternatively, a computing device at a distribution facility (such as the device including UI 118) may begin and then pause an incomplete label transaction and a third party mobile device 121 may receive the incomplete transaction's machine-readable identifier upon request to resume the label transaction in the induction application 120. Label transactions may be paused, saved, and resumed freely between the devices in communication on the distribution network 180, allowing for flexibility for self-service senders seeking to drop off an item 130 at a distribution facility 160.

At block 312, the label transaction is completed on the second device. Completion of a transaction may include providing payment to the induction application for the label being requested, along with providing any necessary information required to create the label. Upon successful completion of the transferred label transaction on the second device, at block 314, the distribution server 182 stores the information input in the label transaction to the data storage 184 and uses this stored information to create a label, which is also stored in data storage 184 for production and generation (e.g., printing) upon request. In this way, the label transaction transfer routine 300 concludes at block 316.

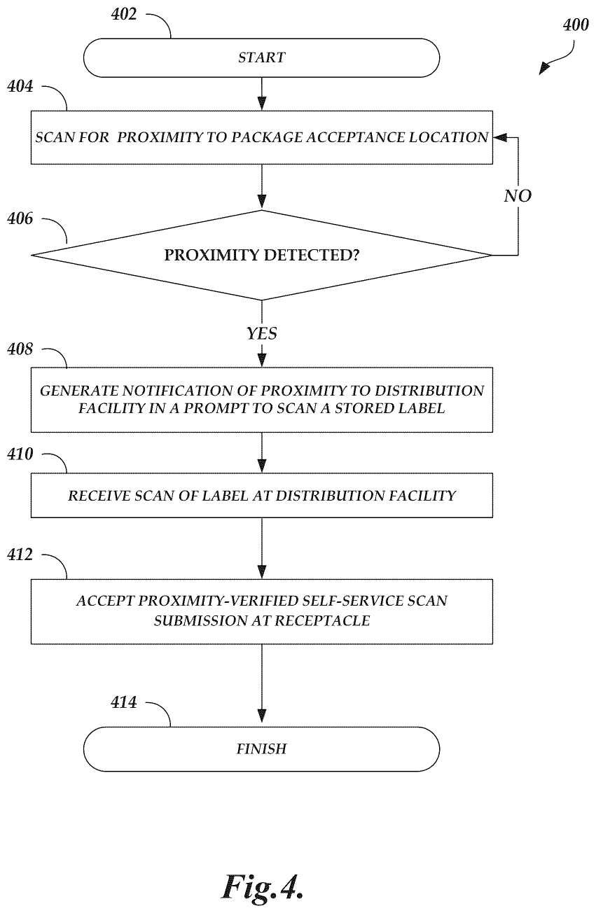

FIG. 4 is a flow chart depicting an embodiment of a process 400 for conducting a proximity-verified self-service acceptance scan of a label for an item to be inducted using the proximity detection capabilities of an induction application 120 in communication with an authorized item receptacle. The routine begins at block 402, and at block 404, the induction application residing on a third party mobile device 121 passively scans the third party mobile device's location in a background process, assuming such functionality has been authorized by the user of the device, whether passively or actively. A number of different methods and technologies may be used to determine the location of the third party mobile device, including any location serves or geolocation capabilities native to the device. Alternatively, the induction application itself may include geolocation capabilities or may make use of location indicators or metadata from items such as stored photographs in order to determine the location of either a user or a stored label.

At decision state 406, if the device with the induction application 120 detects it is within the relevant proximity it is scanning for (namely a predetermined proximity geofence 170 defining the location of any number of distribution facilities 160 or a subset of such a facility, such as a self-service kiosk 110), it proceeds to block 408. However, if proximity within a geofence 170 is not detected, the induction application returns to block 404 to continue scanning for proximity.

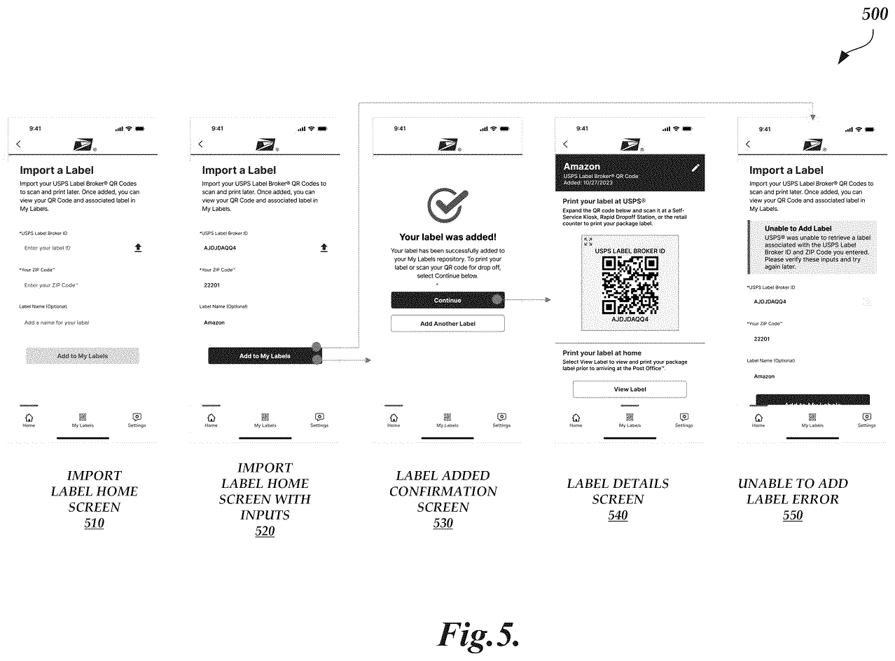

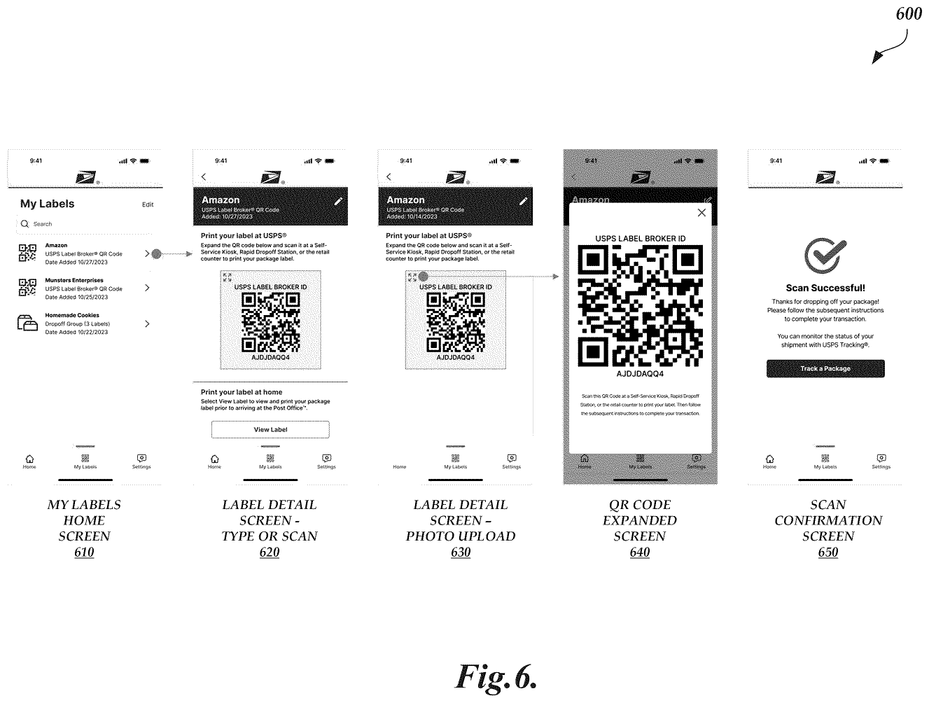

At block 408, the induction application 120 may prompt the user when the user enters within a predetermined proximity geofence 170 defining the location of a distribution facility 160 or one of its subsets such as a self-service kiosk 110. In some embodiments, because multiple labels ready for use may be stored in the induction application on a third party mobile device 121, this prompt will ask a user if they would like to scan their stored label at the relevant distribution facility 160. Further, this prompt may, upon user interaction, open the induction application 120 to a screen storing the label for quick user access, as will be discussed in relation to FIG. 5 and FIG. 6. In some embodiments, at block 408, the distribution server also stores an indicator in data storage 184 received from the induction application 120 indicating a positive confirmation of the present proximity of the induction application 120.

At block 410, the user receiving the prompt enters the distribution facility for a self-service proximity-verified induction of an item at a distribution facility. In some embodiments, the user may approach a self-service kiosk 110 and enter a queue through the induction application 120 on the third party mobile device 121. Upon reaching the front of the queue for the kiosk, the user may use the scanner 117 to scan the stored label (e.g., a QR code or barcode displayed within the induction application 120 tied to the label information, a digital representation of the label, or a physically printed label the user printed at an earlier time). If the user has more than one label to scan, they may do so at this time using a scanner 117 at the self-service kiosk 110. The distribution server may receive the information contained in this scan from the scanner 117 over the distribution network 180. During block 410, tools at the self-service kiosk may be used to generate the label (e.g., weigh or measure the item, print the label if not already printed, present the item for submission at the authorized item receptacle 119, etc.).

At block 412, based at least in part on the fact that the proximity indicator stored in data storage 184 for the induction application's current transaction location indicates a positive confirmation of the required proximity within geofence 170, the distribution server 182 makes a determination to accept the self-service scan submission of the item 130 at the authorized item receptacle 119. In this way, fraudulent self-service scan submissions can be filtered out through the process of proximity detection: only self-service scan submissions of items 130 with labels 132 actually present at the correct distribution facility 160 may be received into the authorized item receptacles 119. At block 414, the routine 400 concludes having successfully received a self-service item for induction.

FIG. 5 depicts illustrative wireframe examples from an induction application 120 in which a label is imported to the induction application 120. At the first wireframe 510, an example screen is provided within an induction application 120 for a home screen allowing for different methods of importing an existing label to the induction application 120. For example, the induction application 120 may prompt for a label ID, a zip code, and an optional name for the label at the import screen. Turning to example wireframe 520, after filling required information for the label, a user may choose a button allowing the label corresponding to the information input to be added to the labels stored within that user's account on the induction application on their third party mobile device 121. At wireframe 530, an example screen is depicted displaying a success message to the user, letting them know that the label was successfully added to their label repository on the induction application 120. The user has the option to add another label, or further continue the process with the label they just added. If the user chooses to continue the process with the label they just added, an example screen such as wireframe 540 may appear. In wireframe 540, an example machine-readable identifier for the label 132 is displayed (in this case, an encrypted QR code and label identifier). This wireframe 540 may be expanded and presented at a scanner 117 of a self-service kiosk 110 (and subsequently printed by a printer 116 if necessary), a manned service counter 150, or anywhere in a distribution facility 160 that a labeled item may be received for induction. Wireframe 540 also includes the option for a user to view and print their label locally on a home printer outside of the distribution network 180.

Wireframe 550 displays an example of an error screen that may be displayed to a user if a user is unable to add a label to their repository in the induction application 120. Wireframe 550 includes an error notification letting the user know that something in their input was either incorrect or otherwise not correlated with any existing label stored in data storage 184 of the distribution network 180. Wireframe 550 also displays the same input fields from wireframe 510 and 520 once again, so that the user may try again with the accurate input for a label 132 as desired.

FIG. 6 depicts illustrative wireframe examples for an induction application 120 in which a machine-readable identifier for a label 132 is displayed for scanning (e.g., by a scanner 117). At illustrative wireframe 610, a home screen for a user's label repository displays high level details for three labels they currently have stored in their label repository on the induction application 120. In this example, the label repository lists the label name, the label type (QR code), and the date the label was added to the repository. The user may select a label from the list on wireframe 610 to view a detail screen for that particular label. Illustrative wireframe 620 displays a detail screen for the selected label from the repository. The label detail screen includes the machine-readable identifier for the label (in this case, an encrypted QR code and label ID). Like wireframe 540, wireframe 620 may be expanded and presented at a scanner 117 of a self-service kiosk 110 (and subsequently printed by a printer 116 if necessary), a manned service counter 150, or anywhere in a distribution facility 160 that a labeled item may be received for induction. Wireframe 620 also includes the option for a user to view and print their label locally on a home printer outside of the distribution network 180.

In some embodiments, such as wireframe 630, the induction application 120 allows a user to upload a photo of a machine-readable identifier for the label to their repository rather than retrieving the label from user input through the distribution server (as seen in wireframe 510). Such a photo may be stored on their device, such as native applications for photos on a third party mobile device 121. The user may have saved such a photo to their device during a label transaction at an earlier point in time. Wireframe 630 also displays an option in the corner to expand the QR code. Upon selection of this option, a screen such as illustrative wireframe 640 displays an expanded machine-readable identifier for a label (in this case, an encrypted QR code). The expanded view of wireframe 640 may be used for scanning at a scanner 117 of a self-service kiosk 110 (and subsequently printed by a printer 116 if necessary), a manned service counter 150, or anywhere in a distribution facility 160 that a labeled item may be received for induction. Upon a successful scan of wireframe 640, the induction application 120 displays a screen such as illustrative wireframe 650, notifying the user that their scan was successful and providing them the option to track the item that they just submitted to the distribution facility 160.

In some embodiments, the induction application 120 includes a virtual agent that provides a concierge experience for the user. For example, the virtual agent may comprise software that utilizes artificial intelligence tools (e.g., large language models) to host a dynamic conversation with the user to better understand the user's needs as they make use of the induction application 120. In some embodiments, the virtual agent of the induction application 120 may serve as a substitute for calling a customer support line or reaching out to a live chat for customer support in the app.

For example, a user may enter a personalized request to the virtual agent: “Find the nearest post office that is open now with a smart locker,” or “I would like to ship a flat rate package that needs to arrive in three days. My budget is fifteen dollars. My package for delivery is about 5 inches by 3 inches by 2 inches,” or “This package seems lost-can someone look into it and tap the tracking number for active but late in transit shipments to create service requests.” These examples are simply illustrative of the wide array of customer needs that an AI virtual agent of the induction application 120 may be able to service in real time. The virtual agent may make use of any data provided by consent of the user to the third party mobile device 121 to the induction application 120 (e.g., location, time, stored photos) in order to better address user requests. In some embodiments, the virtual agent may be powered by deterministic algorithms that anticipate common user scenarios during item induction.

In some embodiments, the Label Broker APIs 260 may consolidate a plurality of encrypted QR codes into a single composite encrypted QR code captured on the label for the item 130. This single composite encrypted QR code may consolidate all relevant data to be used by kiosks, devices, and stations (e.g., authorized item receptacle 119, scanner 117, printer 116, item weight measuring device 114, item dimension measuring device 112, self service kiosk 110) of the item acceptance location. In some embodiments, relevant data stored in the single composite encrypted QR code may include, for example, data associated with smart lockers, label identifiers provided by different mailing companies, self-service acceptance kiosks, or extended hours for access at the facility.

In some embodiments, the label 132 for the item 130 may comprise data facilitating the ability to ship the item 130 to and from smart lockers (e.g., rather than home addresses). By facilitating shipping to smart lockers, the label 132 allows the sender of an item 130 to select a smart locker at the facility closest in proximity to the recipient, allowing the sender to use the smart locker address as the return address should the recipient require a return address at some point during the transaction. In this way, the label 132 may protect the data privacy (e.g., address data) for both the sender and the receiver of the item 130. Moreover, the label 132 may reduce addressing issues and delivery issues through the use of smart lockers. In some embodiments, directing a label 132 to a smart locker may further reduce the cost associated with street delivery labor, thus making the delivery of the item 130 more cost effective.

In some embodiments, the label 132 for the item 130 may comprise data facilitating the ability to ship the item 130 to and from unused Post Office (“P.O.”) boxes at post offices (e.g., rather than home addresses). By facilitating shipping to unused P.O. boxes, the label 132 allows the sender of an item 130 to select an unused P.O. box at the facility closest in proximity to the recipient, allowing the sender to use the unused P.O. box address as the return address should the recipient require a return address at some point during the transaction. In this way, the label 132 may protect the data privacy (e.g., address data) for both the sender and the receiver of the item 130. Moreover, the label 132 may reduce addressing issues and delivery issues through the use of unused P.O. boxes. In some embodiments, directing a label 132 to an unused P.O. box may further reduce the cost associated with street delivery labor, thus making the delivery of the item 130 more cost effective. Moreover, delivery to an unused P.O. box may reduce hardware deployment needs and maintenance costs in some embodiments.

In embodiments described herein, a user can receive an electronic version of a label, or a code indicative of a label via an email, a text message, a photo, or other means. The user can have a mobile application provided by a logistics company which can import the image of the label or the code, by, for example, tapping and holding on the code, by sharing the code with the application, etc. The mobile application can read the code and recreate the code using the original URL to import the code into the application. The code can be stored by the application as a photo with embedded information or in a digital wallet on a user's mobile device. The user can use the code and the application at a shipping location to download or retrieve a physical version of the shipping label.

In some embodiments, the mobile application will only allow, authorize and transmit a self-service scan of the label or code if it detects the device on which the mobile application is running is in communication with a beacon, such as a Bluetooth beacon at a shipping location or facility, or if the device is in a geofence of a location authorized by the shipping or logistics entity. In some embodiments, the user can scan the package or label on a package and store the image in the device for use at a location, but the application will not transmit the label for induction of the package until the device is within proximity of an authorized location.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The present disclosure refers to processor-implemented steps for processing information in the system. Instructions can be implemented in software, firmware or hardware and include any type of programmed step undertaken by components of the system.

The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The system hub 210 may comprise a processor 212 such as, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series®, or FX® processor, or the like. The processors 212 and 305 typically have conventional address lines, conventional data lines, and one or more conventional control lines.

The system may be used in connection with various operating systems such as Linux®, UNIX®, MacOS®, or Microsoft Windows®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

Those of skill will further recognize that the various illustrative logical blocks, modules, circuits, and algorithm steps described in connection with the embodiments disclosed herein may be implemented as electronic hardware, software stored on a computer-readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Memory Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), Flash, Java, .net, web services, and rich site summary (RSS). In some implementations, a UI may be included in a stand-alone client (for example, thick client, fat client) configured to communicate (e.g., send or receive data) in accordance with one or more of the aspects described.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

What is claimed is:

1. A system for labeled induction of an item into a distribution network, the system comprising:
a sender communication device to:
scan, using a geolocation sensor, for an item acceptance location within a predefined radius from the sender communication device;
determine that the item acceptance location is within the predefined radius from the sender communication device;
generate a proximity notification comprising a prompt to scan a stored label associated with an item to deposit at the item acceptance location; and
display the stored label to distribute the item via a distribution network;
a distribution server of the item acceptance location, wherein the distribution server is configured to:
receive, from the sender communication device, a scan of the stored label; and
receive, at an induction communication device, a self-service deposit of the item associated with the stored label for distribution in the distribution network, wherein the self-service deposit is based on the determination that the item acceptance location is within the predefined radius from the sender communication device.

2. The system of claim 1, wherein the stored label is created by:
beginning a label creation at a first device;
pausing the label creation before completing a transaction;
storing data from the label creation in data storage as an incomplete transaction via the distribution server;
receiving an identifier for the incomplete transaction associated with the label creation on a second device;
completing the incomplete transaction on the second device; and
creating the stored label.

3. The system of claim 1, wherein the induction communication device communicates with a kiosk comprising functionality to generate a physical label.

4. The system of claim 1, wherein the distribution server is further configured to:
receive, from a scanning device, scanned information from a physical label;
confirm that the scanned information corresponds to the item; and
route the item to an item processing equipment for a distribution network based at least in part on the scanned information.

5. The system of claim 1, wherein the stored label includes an encrypted machine-readable identifier indicating that the physical label was generated by the distribution server based on a request from a label provider.

6. The system of claim 1, wherein the distribution server is further configured to:
receive, via the induction communication device, a confirmation that a physical label has been created; and
store, in a data storage device, an indicator in association with an encrypted machine-readable identifier, wherein the indicator indicates that the physical label has been created.

7. The system of claim 6, wherein the distribution server is further configured to:
receive, from another communication device, the encrypted machine-readable identifier for the stored label;
determine, based on the indicator and the encrypted machine-readable identifier, that the physical label has been created; and
transmit a message to the another communication device indicating that the physical label has been created.

8. The system of claim 1, further comprising a labeling kiosk including an input interface for receiving machine readable identifiers for labels, wherein receiving an encrypted machine-readable identifier comprises receiving the encrypted machine-readable identifier from the labeling kiosk, and wherein the induction communication device comprises the labeling kiosk, and wherein the input interface comprises at least one of: (a) a scanning device; or (b) a graphical user interface.

9. The system of claim 1, wherein the stored label comprises a data file containing information for generating a physical label.

10. The system of claim 1, wherein the stored label comprises an image of the label.

11. The system of claim 1, wherein receiving an encrypted machine-readable identifier comprises receiving the encrypted machine-readable identifier from portable, handheld scanning device associated with a distribution resource of the distribution network.

12. The system of claim 1, wherein the distribution server is further configured to transmit, to the sender communication device, an encrypted machine-readable identifier for the stored label.

13. The system of claim 1, wherein the distribution server is further configured to transmit, to a label provider, an encrypted machine-readable identifier for the stored label.

14. A method for labeled induction of an item into a distribution network, the method comprising:
by a sender communication device:
scanning, using a geolocation sensor, for an item acceptance location within a predefined radius from the sender communication device;
determining that the item acceptance location is within the predefined radius from the sender communication device;
generating a proximity notification comprising a prompt to scan a stored label associated with an item to deposit at the item acceptance location; and
displaying the stored label to distribute the item via a distribution network; and
by a distribution server of the item acceptance location:
receiving, from the sender communication device, a scan of the stored label; and
receiving, at an induction communication device, a self-service deposit of the item associated with the stored label for distribution in the distribution network, wherein the self-service deposit is based on the determination that the item acceptance location is within the predefined radius from the sender communication device.

15. The method of claim 14, wherein creating the stored label further comprises:
beginning a label creation at a first device;
pausing the label creation before completing a transaction;
storing data from the label creation in data storage as an incomplete transaction via the distribution server;
receiving an identifier for the incomplete transaction associated with the label creation on a second device;
completing the incomplete transaction on the second device; and
creating the stored label.

16. The method of claim 14, wherein the induction communication device communicates with a kiosk comprising functionality to generate a physical label.

17. The method of claim 14, further comprising:
receiving, from a scanning device, scanned information from a physical label;
confirming that the scanned information corresponds to the item; and
routing the item to an item processing equipment for a distribution network based at least in part on the scanned information.

18. The method of claim 14, wherein the stored label includes an encrypted machine-readable identifier indicating that a physical label was generated by the distribution server based on a request from a label provider.

19. The method of claim 14, wherein the item acceptance location comprises a labeling kiosk including an input interface for receiving machine readable identifiers for labels, wherein receiving an encrypted machine-readable identifier comprises receiving the encrypted machine-readable identifier from the labeling kiosk, and wherein the induction communication device comprises the labeling kiosk, and wherein the input interface comprises at least one of: (a) a scanning device; or (b) a graphical user interface.

20. The method of claim 14, wherein the stored label comprises a data file containing information for generating a physical label.
